(19) United States
(12) Patent Application Publication
(10) Pub. No.: US 2026/0155966 A1
(43) Pub. Date: Jun. 4, 2026

(54) Hardware Security Module Implementation as Edge Devices in a Networked System

(71) Applicant: Bank of America Corporation, Charlotte, NC (US)

(72) Inventors: Pratap Dande, Saint Johns, FL (US); Gilberto Dos Santos, Jacksonville, FL (US); JayaBalaji Murugan, Chennai (IN); Patricia A. Medeiros, Barrington, RI (US)

(21) Appl. No.: 18/968,024

(22) Filed: Dec. 4, 2024

(51) Int. Cl. H04L 9/08

(52) U.S. Cl. CPC H04L 9/088

(57) ABSTRACT

Hardware security modules (HSM) may be implemented at distributed edge devices to provide faster and dynamic processing of data. HSM-implemented edge devices may be used to process data to enhance data security. For example, HSM edge devices may provide encryption, decryption, data masking, tokenization, or anonymization. The HSM edge devices may interface with one or more blockchains to invoke smart contracts, and to record data transaction events. In some examples, smart contracts may be used to provide uniform policies and functions across multiple edge devices and their corresponding end user devices.

### BACKGROUND

Aspects described herein relate to electrical computers, networks, systems, and devices for storing, managing, and transacting data in an efficient, secure, and reliable manner.

In many existing computer systems, hardware security modules (HSMs) have become popular as a way to improve data security. For example, HSMs are often configured to store encryption/decryption keys, confidential information, personal information, as well as to perform encryption and decryption functions. However, the implementation of HSMs in organization servers and other more centralized systems (e.g., information technology infrastructure and applications) can be complex and challenging. Additionally, acquiring and deploying HSMs can be costly, requiring investment in hardware, software licenses, maintenance, and support services. Without proper implementation, security, and monitoring, HSMs may be susceptible to attacks such as side-channel attacks, physical tampering, insider threats. Moreover, ensuring that HSM deployments and configurations comply with relevant regulatory frameworks and industry standards can be challenging and may require regular audits and assessments.

Further, when an HSM is configured to perform encryption and decryption in a networked system and enforce other security policies, using centralized HSMs may introduce latency and performance overhead, especially for high-volume or real-time applications. Accordingly, with HSMs implemented in centralized severs or systems, there may be delays in security policy access, deployment, and enforcement. Moreover, developing and implementing robust key management policies and procedures is typically important in such systems, but can be time-consuming and resource intensive.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

By addressing one or more of the above noted challenges, organizations can enhance the performance of data management functions (e.g., data obfuscation, encryption), strengthen data security and compliance, and mitigate risks associated with sensitive data handling.

Accordingly, aspects described herein relate to systems, methods, apparatuses and processes for implementing HSMs at edge devices in a networked organization or system. Instead of, or in addition to, implementing HSMs at a central server, a system may implement one or more HSMs at multiple edge devices geographically located closer to one or more end user devices than the central server. By implementing and distributing HSMs at edge locations and devices, latency in communications with the central server and the resource consumption at the central server may be significantly reduced. Further, deploying HSMs at edge locations or systems may provide an anonymization capability for user devices or other terminals seeking to transact data with the central server.

According to one or more aspects, HSMs implemented in a networked system may further be implemented as part of a blockchain network. For example, data encryption/decryption keys managed by an HSM may be stored at nodes in the blockchain network so as to provide enhanced access security, immutable storage, and the ability to audit encryption information ownership and access.

According to one or more further aspects, the systems, methods, apparatuses and processes include configuring blockchain smart contracts to verify user permissions and enforce data access and management policies. These smart contracts may be accessed, invoked, and applied by the edge device HSMs in order to respond to various data access and management requests. Use of smart contracts may allow for more uniform policy enforcement and reduce the configuration and implementation requirements for each HSM device.

According to one or more further aspects, systems, methods, apparatuses and processes provide edge device HSMs configured to perform dynamic data obfuscation such as masking and de-identification of sensitive information in real-time. For example, edge device HSMs may protect information going to a server from a user device and/or going to a user device from the server using a variety of processes, including tokenization, masking, and anonymization.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for an HSM edge device system in accordance with one or more aspects described herein;

FIG. 2 is a flowchart illustrating an example process for secure data transmission via a hardware-secured edge computing system according to one or more aspects described herein;

FIG. 3 is a flowchart illustrating an example process for processing received data by an HSM edge device according to one or more aspects described herein;

FIG. 4 is a flowchart illustrating an example process for using a blockchain to manage data access control according to one or more aspects described herein;

FIG. 5 is a flowchart illustrating an example process for using smart contracts in a blockchain to perform one or more transactions and functions according to one or more aspects described herein; and

FIG. 6 depicts an illustrative architecture and operating environment for a hardware secure data and transaction processing system according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, hardware security modules (HSMs) may be used in an organization to securely manage, process, transmit, receive, and/or otherwise transact in data and information. In some instances, those HSMs are implemented at central or centralized systems or servers that interface with and handle requests from numerous devices, including end user devices and intermediate systems across local and wide area networks. Implementing HSMs in such a way may create significant loads on the centralized systems and servers as well as increase latency, and introduce possible security vulnerabilities between the centralized systems and end user or intermediate devices. For example, data transmitted to and from the HSMs might not be secured or anonymized to the extent necessary and have vulnerabilities to potential attacks and security breaches.

Accordingly, aspects described herein provide systems and methods for improving the efficiency and security of data and communication security management. For example, systems and methods described herein provide for distributed HSMs at edge devices in order to moderate the resource requirements at any one HSM. Accordingly, no single or multiple centralized servers or systems are required to handle the data security management needs of all end user devices within an organization or other system. Edge devices may be located at locations more proximate to end user devices than one or more central servers or systems. In some examples, the number of edge devices implementing an HSM may be determined based on a desired or threshold processing load for each of the edge devices, a desired maximum latency, and/or a threshold geographic proximity to each end user device.

According to one or more further aspects, HSMs may be implemented using blockchain data, security, and access control management. For example, in an environment where edge devices implement HSMs, each of the edge devices and HSMs may be configured to access data and enforce security policies (e.g., access control management) based on the same blockchain network. Data may be stored within the blockchain nodes to provide further security and governance. Further, security policies may be defined in the blockchain, e.g., as smart contracts, which may allow a system to enforce uniform policies and requirements.

Additionally, edge device HSMs may be configured to provide anonymization functionality to address privacy and confidentiality. For example, end user devices may transact data with one or more servers or systems. In order to protect the privacy of those user devices (and the data), that data may be anonymized, tokenized, masked, or otherwise obfuscated or protected from general view or access. Similarly, data from a server or other system may also be protected from full view and access by end user devices, e.g., depending on a user's access privileges or security clearance level.

These and various other arrangements will be discussed more fully below.

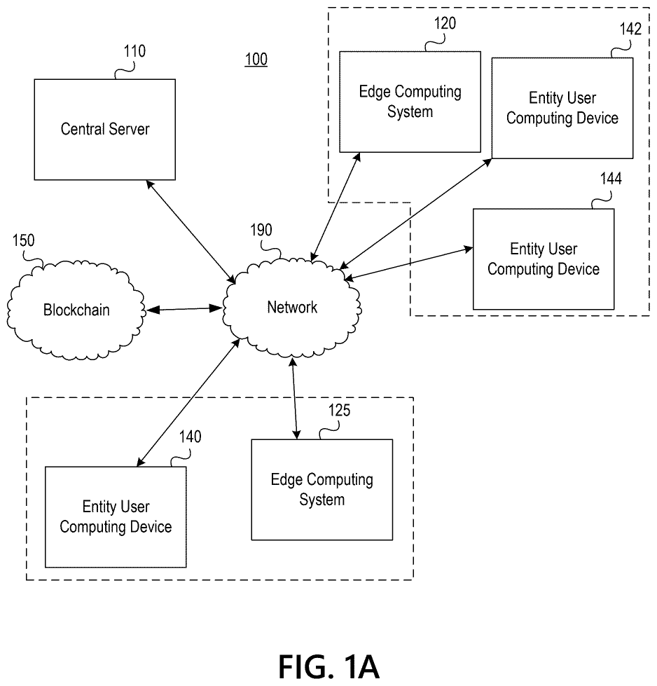

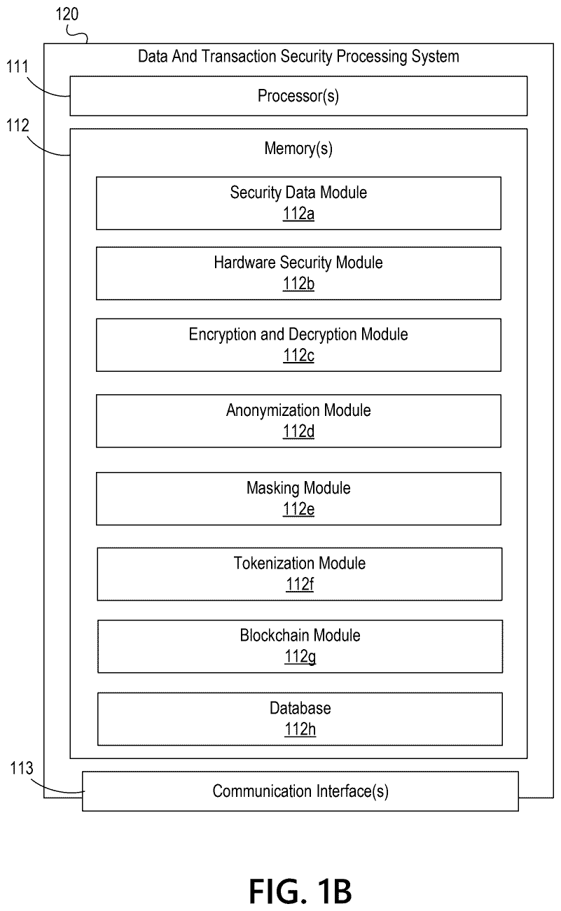

FIGS. 1A-1B depict an illustrative computing environment for implementing a hardware-secured data governance and security system and process in accordance with one or more aspects described herein. Referring to FIG. 1A, computing environment 100 may include one or more computing devices and/or other computing systems. For example, computing environment 100 may include central server or system 110, hardware-secured edge computing system 120, hardware-secured edge computing system 125, and entity user computing devices 140, 142, and 144. Although one central server 110, two edge computing systems 120, 125 and three entity user computing devices 140, 142, 144 are shown, any number of systems or devices may be used without departing from the invention.

Central server 110 may include one or more computing devices (e.g., servers, personal computers (PCs), routers, mobile devices, server blades, or the like) and/or one or more computing components (e.g., memory, processor, and the like) and may be configured to perform a variety of functions and have a variety of capabilities for an organization, entity, or system. For example, the central server 110 may correspond to an Internet Service Provider (ISP) and may be configured to route data communications between end user devices such as user computing devices 140, 142, and 144, and/or external devices, or to other provide other network functions. In another example, the central server 110 may correspond to a financial transaction system configured to manage financial information, perform financial transactions such as payments, loans, withdrawals, deposits, and the like, and provide auditing and reporting functions. In still another example, central server 110 may correspond to an electronic security system configured to store, manage, and transact data in a secure manner. In each of these arrangements, central server 110 may be configured to communicate with a plurality of devices including user computing devices 140, 142, and 144 as well as hardware-secured edge computing systems 120 and 125. For example, and as shown in FIG. 1, central server 110 may be configured to communicate with user computing devices 140, 142, and 144 through hardware-secured edge computing systems 120 and 125.

Each of hardware-secured edge computing systems 120 and 125 may be or include one or more hardware security modules (HSMs), computing devices (e.g., servers, personal computers (PCs), routers, mobile devices, server blades, or the like) and/or one or more computing components (e.g., memory, processor (e.g., cryptoprocessors), and the like). An HSM may refer to a hardened, tamper-resistant hardware device or component that is configured to secure data through various means including encryption. HSMs may also be configured to generate, manage, secure, update, and transact (send, receive, modify, process, etc.) in cryptographic information such as encryption and decryption keys. In one example, hardware-secured edge computing systems 120 and 125 may be located more proximately to one or more of entity user computing devices 140, 142, and 144 than central server 110 is to any of devices 140, 142, and 144. For example, in FIG. 1, hardware-secured edge computing system 120 is co-located with entity user computing device 142 and 144, while hardware-secured edge computing system 125 is co-located with entity user computing device 140. This may allow hardware-secured edge computing systems 120 and 125 to provide data security capabilities and functionality with less latency and more quickly than if all data security functions are provided by and invoked from central server 110. For example, because there may be more hardware-secured edge computing systems than central servers, the processing load and task load may be better distributed across these edge computing systems and decrease processing time. Moreover, because the edge computing systems may be located physically closer to user computing devices, requests for data transactions (e.g., encryption, decryption, retrievals, storage, key management) or other types of transactions, and outputs and results of those transactions, may be communicated more quickly between the edge computing system and the user computing device. In some examples, the edge computing systems 120 and 125 may be connected through a local area network to their corresponding (e.g., co-located) user computing devices 140, 142, and 144. The dashed boxes in FIG. 1A may correspond to a local area network between the devices therein. Additionally, with the distributed nature of the data processing tasks at the multiple edge computing systems, network connections might be less congested than if all data processing tasks (or other communications) are directed to fewer central servers, such as central server 110.

According to one or more aspects, the hardware-secured edge computing systems 120 and 125 may be configured to anonymize communications between the central server 110 and entity user computing device 140, 142, and 144. For example, if a user requesting a transaction or information from the central server 110 or other central system of an organization would like the transaction or other request to remain anonymous, the hardware-secured edge computing system 120 may receive the request, redact, remove, or otherwise anonymize the request prior to sending the request to the central server 110. Similarly, if central server 110 determines that a source of information or data being sent to an end user device (e.g., device 140, 142 or 144) is confidential or otherwise should be hidden from the end user, the central server 110 may direct the hardware-secured edge computing system 120 or 125 to redact, remove, or otherwise anonymize the source of the data or information to be sent to the end user device. In short, the hardware-secured edge computing system 120 or 125 may act as an intermediary to facilitate anonymous transactions. In some examples, anonymization may include hiding a source IP address or other identifier associated with transaction communications between two parties.

Additionally, the hardware-secured edge computing systems 120 and 125 may provide obfuscation functions such as masking or tokenization capabilities for protecting the security and/or confidentiality of data. For example, the hardware-secured edge computing systems 120 and 125 may determine whether a user or user entity computing device 140, 142, or 144 is authorized to view or receive certain types of data and/or if the data is sensitive or confidential. If the user or device does not have adequate authorization and/or if the data is sensitive or confidential, the hardware-secured edge computing system 120 or 125 may be configured to modify the requested data in such a way that the portions which the user or user entity computing device is not authorized to view or receive is masked or otherwise hidden (e.g., redacted, scrambled). Hardware-secured edge computing systems 120 and 125 may be configured to provide this functionality in real-time, thereby providing dynamic masking in response to data requests or other transactions involving sensitive information. That is, central server 110 or another system might not be required to pre-generate and store both a redacted or masked version of data as well as an unredacted or non-masked version of the data. Instead, the masked version may be generated on-the-fly. Moreover, because such transaction processing may be distributed across multiple hardware-secured edge computing systems such as systems 120 and 125 that are more closely located to entity user computing devices 140, 142, and/or 144, the data masking process may be performed more quickly (e.g., given lower processing loads at each edge system and/or because of quicker network response times in light of geographic proximity) and thus, in a more dynamic manner than would be performed by one or more central servers or systems, such as central server 110.

Additionally or alternatively, computing environment 100 may be supported by one or more blockchain networks such as blockchain network 150. For example, one or more of the entity user computing devices 140, 142, 144, hardware-secured edge computing systems 120, 125 and/or the central server 110 may be configured to record transactions, communications, data and the like in the blockchain so as to provide further data security and reliability. Accordingly, encryption keys, transaction data, historical records, and other information may be stored using the blockchain network 150 so that the reliability of the data can be improved. Moreover, using a blockchain network 150 to manage such information may provide a reliable audit trail for changes and other events (e.g., data access, encryption, decryption, user authorization, user login). In one example, encryption keys may be stored in nodes of the blockchain network 150, and accessed through network 150. Modifications to those keys (or other data) may then be tracked through the blockchain network 150. For example, each modification (e.g., transaction) on a piece of data may be recorded as a node in the blockchain 150. In one or more arrangements, different blockchains may be used to record events, store data, and the like for different types of data, different departments or user roles, different data transactions, and the like.

According to one or more further aspects, blockchain network 150 may include one or more smart contracts. Smart contracts include code or instructions for performing certain tasks or functions. Smart contracts may evaluate input data to determine whether the task or function is to be executed, and if so, cause those functions and tasks to be performed. In one example, smart contracts may be used to authorize users for obtaining decryption or encryption keys. In another example, smart contracts may be used to enforce security or confidentiality policies such as data masking or tokenization.

Entity user computing devices 140, 142, 144 may be or include a computing device such as a desktop computer, laptop computer, tablet, smartphone, wearable device, and the like, that is associated with a user (e.g., an employee) of the organization. Entity user computing device 140, 142, and/or 144 may communicate with central server 110 and/or hardware-secured entity computing systems 120, 125 to conduct transactions, obtain information, communicate with one or more other parties, and the like and/or combinations thereof. In some arrangements, the entity user computing device 140, 142, and/or 144 may be used to monitor transactions or interface with customers and other users. In other examples, the entity user computing device 140, 142, and/or 144 may be used to confirm or approve actions requested by customers or other users or systems. For example, if a request is made to authorize a large transaction amount, the approval or confirmation may be entered through entity user computing device 140, 142, and/or 144. Ahead of the authorization, a user may obtain information about one or more entities involved in the financial transaction through entity user computing device 140, 142, and/or 144, and/or communicate message regarding the financial transaction to one or more other users.

In one or more arrangements, entity user computing devices 140, 142, 144 may include or refer to (at least in part) customer or user devices that are outside of a particular organization. For example, a financial institution may have many customers, each performing transactions through one or more user devices. Accordingly, those transactions (e.g., data requests, communications with other entities through the organization, financial transactions) may be facilitated by hardware-secured entity computing systems 120, 125 as discussed herein. In one example, a customer may wish to make a deposit in his or her financial account. That customer may perform the transaction through his or her user device (e.g., device 140). If that customer would like to anonymize his or her location, the anonymization may be handled by one or more of the hardware-secured entity computing systems 120, 125 to anonymize that information prior to the transaction being sent to the central server 110 for processing.

As described, computing environment 100 also may include one or more networks, which may interconnect one or more of central server 110, hardware-secured entity computing system 120, hardware-secured entity computing system 125, and/or entity user computing device 140. For example, computing environment 100 may include network 190. Network 190 may include one or more sub-networks (e.g., Local Area Networks (LANs), Wide Area Networks (WANs), or the like). For example, network 190 may include a first local area network connecting hardware-secured entity computing system 120 and entity user computing devices 142 and 144, as well as a second local area network connecting hardware-secured entity computing system 120 and entity user computing device 140.

Network 190 may be associated with a particular organization (e.g., a corporation, financial institution, educational institution, governmental institution, or the like) and may be a private network interconnecting one or more computing devices associated with the organization. For example, central server 110, hardware-secured entity computing system 120, hardware-secured entity computing system 125, and/or entity user computing devices 140, 142, 144 may be associated with an organization (e.g., a financial institution), and network 190 may be associated with and/or operated by the organization, and may include one or more networks (e.g., LANs, WANs, virtual private networks (VPNs), or the like) that interconnect central server 110, hardware-secured entity computing system 120, hardware-secured entity computing system 125, and/or entity user computing device 140, 142, and/or 144 and one or more other computing devices and/or computer systems that are used by, operated by, and/or otherwise associated with the organization. Additionally or alternatively, network 190 may be a public network, such as the internet, that may connect the systems and devices described. In yet other examples, network 190 may include a combination of public and private networks.

Referring to FIG. 1B, a data and transaction security processing system such as hardware-secured entity computing system 120 may include one or more processors 111, memory 112, and communication interface 113. A data bus may interconnect processor(s) 111, memory 112, and communication interface 113. Communication interface 113 may be a network interface configured to support communication between data and transaction security processing system 120 and one or more networks (e.g., network 190, or the like). Memory 112 may include one or more program modules having instructions that when executed by processor(s) 111 cause data and transaction security processing system 120 to perform one or more functions described herein and/or one or more databases that may store and/or otherwise maintain information which may be used by such program modules and/or processor(s) 111. In some instances, the one or more program modules and/or databases may be stored by and/or maintained in different memory units of data and transaction security processing system 120 and/or by different computing devices that may form and/or otherwise make up data and transaction security processing system 120.

For example, memory 112 may have, store and/or include security data module 112a. Security data module 112a may be configured to collect and/or store information about transactions and/or users including a requester, a user identifier, a status, transaction amount, transaction type, financial institutions, product or service associated with the transaction, geographic location of a user, device(s) used to make the transaction or by the user (e.g., device identifier, device type), application or software used by the user (e.g., to make the transaction), and the like. The transaction information may be used to not only process the transaction, but also to determine whether one or more data management policies should be applied to the data associated with the transaction. The security data module 112a may also collect and/or store security information such as security tokens, private/public keys, other encryption information, and the like.

Data and transaction security processing system 120 may further have, store and/or include hardware security module 112b. HSM 112b may be one or more hardware components that are hardware-configured to provide certain functions and implement security protocols. Because HSM 112b is hardware-configured in this manner, these devices may be more tamper-resistant. Accordingly, a risk of hacking may be decreased by using such implementations. For example, in order to change the security protocols of the HSM 112b, a malicious entity may need to physically access and modify or alter the HSM 112b, rather than simply being able to modify software or firmware through a network (e.g., from a remote device). Accordingly, HSM 112b may provide a stronger level of data and transaction security. In one arrangement, HSM 112b may include one or more secure cryptoprocessor chips that further prevents tampering.

HSM 112b may be configured to perform a variety of functions to enhance data and transaction security. For example, HSM 112b may securely generate and manage encryption keys or other cryptographic or security information. Additionally or alternatively, HSM 112b may be configured to control and manage access to securely stored encryption keys for a variety of users or entities. Accordingly, when data and/or communications need to be encrypted or decrypted, the corresponding keys may be securely and reliably retrieved from HSM 112b. Additionally, HSM 112b may validate or authorize a user for retrieving and using security keys. To facilitate key and cryptographic information management, HSM 112b may be configured with various cryptographic algorithms and protocols.

Additionally, data and transaction security processing system 120 may have, store and/or include an encryption and decryption module 112c. Encryption and decryption module 112c may be configured to perform encryption and decryption on data sent to or received from one or more user devices such as entity user computing device 140, 142, or 144. In one example, the encryption and decryption module 112c may detect a transaction request from entity user computing device 140, and that one or more portions of the transaction information is to be encrypted for transmission to a destination system (e.g., a transaction processing system such as central server 110). Accordingly, in response, the encryption and decryption module 112c may extract the one or more portions of the transaction information and obtain encryption information. For example, encryption and decryption module 112c may determine a user or other entity associated with the transaction (e.g., a requesting entity or user) and obtain the security keys associated with that user or entity through HSM 112b. Upon obtaining the security key, the encryption and decryption module 112c may encrypt the one or more portions of the transaction information prior to its transmission to the transaction processing system. In encrypting the data, the encryption and decryption module 112c may also indicate a level of sensitivity or confidentiality associated with the information. In some examples, different levels of sensitivity may be defined for different portions or parts of the data.

On the other hand, if incoming encrypted data (e.g., communication or data directed to an end user device) is received at the data and transaction security processing system 110, encryption and decryption module 112c may be configured to perform decryption of the data prior to transmission to an end user device (e.g., device 140, 142, or 144). Accordingly, encryption and decryption module 112c may perform similar functions as when sending information from an end user device, except that the encryption and decryption module 112c retrieves security keys from HSM 112b for decrypting the data (e.g., rather than for encrypting data). In some cases, decryption and encryption keys may be different from one another or, alternatively, may be the same. Moreover, encrypted data may be accompanied by information identifying one or more levels of sensitivity or confidentiality associated with the encrypted data. Accordingly, encryption and decryption module 112c may determine whether a recipient is authorized to view one or more portions of the encrypted data based on these levels of sensitivity or confidentiality.

Data and transaction security processing system 120 may further have, store and/or include an anonymization module 112d. Anonymization module 112d may be configured to obscure or hide certain identification information. For example, if a source of information or of a transaction wishes to remain anonymous, or partially anonymous, the anonymization module 112d may be configured to dynamically (e.g., real-time, responsive to a request) modify a communication or data to be transmitted such that identifying information is removed, redacted, or otherwise hidden. In one example, a username or real name of an entity may be redacted, scrambled, or removed from data or communications. In another example, an IP address or physical address of an entity may be anonymized from data or communications. A variety of other identification information may similarly be anonymized as desired.

Data and transaction security processing system 120 may have, store and/or include a masking module 112e. Masking module 112e may be configured to perform masking functions with respect to data and communications transferred to and from one or more user devices. For example, similar to the anonymization of data, masking module 112e may redact, remove, or otherwise make non-visible, information that is communicated between a user device and one or more other devices. In one example, masking module 112e may be configured to perform dynamic masking such that information directed to a user can be redacted or otherwise masked in real-time as needed. Similar to data anonymization, data and communications may be redacted or masked according to predefined security policies. For example, a user may be required to have a requisite level of clearance or authorization in order to view certain information or parts of the information. Masking module 112e may make those determinations (e.g., authorization or security level determinations) and appropriately mask data prior to sending the information to the user at their device. Other masking policies may be based on access location (e.g., geographic- or IP-based location differentiation), device type, network type (e.g., public, private, wireless, wired), and the like and/or combinations thereof.

Data and transaction security processing system 120 may have, store and/or include a tokenization module 112f. Tokenization module 112f may be configured to secure certain types or portions of data within a communication or transaction. In one example, tokenization may refer to the replacement of certain sensitive data with a one-time representation of that information. For example, a user's account number may be replaced with a one-time number that is only effective or recognizable as corresponding the user's account for a limited period of time. The token may be securely stored in a database (e.g., a token vault) in association with the user's actual account number. Tokens may be generated as a unique random string of characters and/or numbers. Using tokenization reduces the risk that a malicious actor is able to obtain sensitive information about an entity, a transaction, and the like. In another example, in cases where a user is authorized to view certain data or types of data, a sending system or entity may still wish to add security or authorization for viewing that data. In such instances, tokenization module 112f may replace the data-at-issue with a token that provides secure access to the data. Accordingly, a viewing user may invoke the token to view the information. For example, a token may be a secure link to a website or network site where a user may need to provide authentication information (e.g., a login and password, multifactor authentication, biometric verification) in order to view the data.

According to some aspects, the data and transaction security processing system 120 may also include a blockchain module 112g. Blockchain module 112g may be configured to facilitate access to and management of one or more blockchains configured to store data and records of transactions (e.g., modifications to the data or one or more data storages). For example, blockchain module 112g may serve as an interface between HSM 112b and/or one of the other modules of system 120 to securely store information to and retrieve information from a blockchain. In some arrangements, HSM 112b may record every generation, request for, retrieval of, and/or use of encryption or decryption keys. For example, when encryption and decryption module 112c performs encryption or decryption of data, the retrieval of keys and use thereof may be recorded by HSM 112b in a blockchain as a transaction record. In another example, if keys or other data (e.g., the encrypted or decrypted data) is updated or otherwise modified (e.g., masked, tokenized), a record of that modification or update may be stored in the blockchain for auditing purposes. Using a blockchain network to manage key and data access, use and other transactions may provide a decentralized and transparent way to control distribution of sensitive information. Moreover, a blockchain network may allow a system 120 to authenticate transactions by verifying the integrity of data and its provenance. For example, system 120 may use blockchain module 112g to confirm that a key has not been changed, or that the key has only been changed by trusted sources. This confirmation may be performed by examining blockchain transaction records corresponding to the key information, and determining whether any modifications were performed, authorized, signed, etc. by a trusted entity. In some arrangements, the data and transaction security processing system 120 (as well as system 125) may be a node in the blockchain network.

Further, blockchain module 112g may provide an interface for one or more of the modules of system 120 to access smart contracts. Smart contracts may include code stored in the blockchain that is configured to automatically execute when invoked (e.g., if a condition is true, or some other requirement is satisfied). Smart contracts may be used to perform financial transactions, execute encryption or decryption functions, enforce contractual terms, automate workflows, and the like and/or combinations thereof. For example, a smart contract may be invoked or otherwise used to automatically execute a fund transfer to a business upon determining that the business successfully delivered a product. The same integrity advantages apply to smart contracts as for data governed using a blockchain network. By using one or more blockchain networks, all or multiple devices in an organization may access and enforce the same policies (e.g., through smart contracts), controls, and management without having to configure each individual device separately.

Data and transaction security processing system 120 may further have, store and/or include database 112h. Database 112h may store further data, beyond what is stored in or by security data module 112a. For example, database 112h may store and/or other data that enables performance of aspects described herein by the data and transaction security processing system 120.

Although the data and transaction security processing system is described with respect to hardware-secured edge computing system 120, the same or similar components and configurations may be applied to hardware-secured edge computing system 125 and/or a central server or system such as server 110. For example, each of systems 120, 125, and 110 may be configured as nodes in one or more blockchain networks and/or configured to provide access control and secure management of data such as security keys, customer information, passwords, and the like and/or combinations thereof.

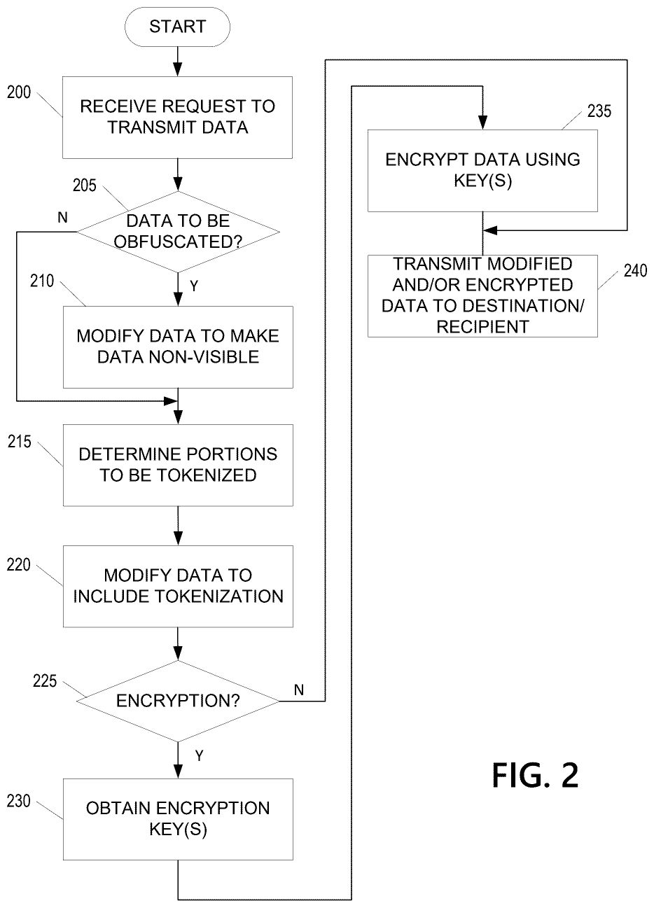

FIG. 2 is a flowchart illustrating a process for secure data transmission between an end user device and one or more other systems via a hardware-secured edge computing system. In step 200, an edge device implementing an HSM (i.e., an HSM edge device) may receive a request to transmit data to another system such as a financial transaction processing server, another user's device, another internal system of an organization, or the like. In one or more arrangements, the transmission request may be received from a user device that is local to the HSM edge device, or more physically proximate to the edge device than to the destination system or server. The user device may be a device of an organization entity or may be a device of a customer or end user of services or products provided by the organization entity. In one example, an internal organization user device may request a transaction to retrieve financial records, access transaction histories, view customer information, audit a transaction, process a dispute, and the like. In another example, the data to be transmitted may correspond to a transaction such as a customer financial transaction (e.g., a payment, a fund request, a mortgage).

In step 205, the HSM edge device may determine whether the data or portions of the data should be hidden or otherwise made non-visible (e.g., obfuscated). For example, certain data may be sensitive or confidential and require a certain clearance or authorization level to view. A number of factors or conditions may be evaluated and considered by the HSM edge device in determining whether data should be hidden. For example, hiding or making data or portions of the data non-visible or non-recognizable to a recipient may be required based on data type, a recipient user title or role, a recipient user's clearance level, a sending user's designation of a sensitivity or confidentiality of the information, a time of day, a geographic location of the sending user device and/or of the destination device, a recipient device type and the like and/or combinations thereof.

If the HSM edge device determines the data or portions of the data are to be hidden or otherwise obfuscated, the HSM edge device may dynamically, and in real-time, modify the data to be transmitted to hide those portions of the data in step 210. For example, the data (or the portions thereof) may be redacted, deleted, scrambled, or otherwise obfuscated. Because the HSM edge device may be located locally to the source user device, the security and confidentiality of the data may be less susceptible to malicious actors. In one or more arrangements, the HSM edge device and the user device may be connected through a local area network that is less susceptible to outside actors attempting to intercept communications between devices.

In steps 215 and 220, the HSM edge device may also determine portions of the data that should be tokenized, and perform the tokenization of those portions of the information, respectively. In one example, if the HSM edge device determines that the data includes a credit card number, an account number, or other user-specific information, the HSM edge device may perform tokenization to help secure that information. One manner of tokenization includes the HSM edge device generating a one-time, unique replacement value (e.g., a string of characters, numbers, symbols, and/or combinations thereof) for data to be tokenized. Those values may then be substituted into the data to be returned to a user or transmitted to a destination entity. Additionally, the HSM edge device may store an association between the one-time replacement value and the real or actual information in a token vault or other secure storage. In some examples, the one-time replacement value may be associated or defined by a lifetime, upon the expiration of which, the replacement value is no longer effective. For example, at the expiration of the lifetime duration, the association in the vault may be deleted or otherwise deactivated.

Another manner of tokenization may include replacing particular types of information with an access token that requires further user authentication to view the tokenized information. Accordingly, the HSM edge device may store the information to be tokenized in a secure location (e.g., a network site such as a website or other server) and replace that information in the data with a link to the location. The secure location may require user authentication prior to displaying or otherwise providing the tokenized information. This link too may be time-limited. In some cases, different types of tokenization may be used depending on the type of information to be protected or secured. For example, personally-identifiable information may be replaced with an access token whereas financial information may be replaced with a limited time, unique token.

In step 225, the HSM edge device may further determine whether the data to be transmitted is to be encrypted. This determination may be performed based on a number of factors and conditions. For example, encryption may be required based on data type, a user title or role, a user's clearance level, a user's designation of a sensitivity or confidentiality of the information, a time of day, a geographic location of the user device and/or of the destination device, a title or role of a receiving user, the clearance level of the receive user, and the like and/or combinations thereof.

In some examples, the HSM edge device may determine whether portions of the data are to be encrypted rather than or in addition to determining whether the data as a whole is to be encrypted. For example, if the transmitted data includes multiple files or parts, HSM edge device may evaluate the sensitivity or confidentiality of each part of file separately. Accordingly, encryption may be decided and implemented on a file-by-file or part-by-part basis.

In step 230, the HSM edge device may obtain one or more encryption keys for encrypting the data or portions of data determined from step 225. In one or more arrangements, the HSM edge device may identify encryption keys based on a sending or recipient user or entity. In other arrangements, the HSM edge device may identify encryption keys based on sending or recipient departments within an organization, transaction or data type, source device type, destination device type, sensitivity or confidentiality level of the information and the like and/or combinations thereof. The encryption keys may be stored locally at the HSM edge device or at another device or network location.

In step 235, the HSM edge device may encrypt the data using the retrieved encryption keys. In some instances, different portions of the data may be encrypted using different keys. The different keys may represent different levels of sensitivity or confidentiality. Keys may also be different depending on information type, an organization or department associated with that data or portion of data, and the like and/or combinations. Additionally, or alternatively, cryptographic algorithms used to encrypt the data may also differ based on similar factors and considerations. Accordingly, different cryptographies may be applied to different portions of data.

In step 240, once the data has been appropriately prepared (e.g., masked, tokenized, and/or encrypted), the processed data may be transmitted to a destination device or system. In one example, the destination device may be a central server of an organization. The central server may perform various processes on the data. For example, the central server may correspond to a financial institution configured to process a financial transaction such as a transfer of funds. Accordingly, the data may include financial account information, financial transaction parameters, and the like, needed to validate and perform the funds transfer.

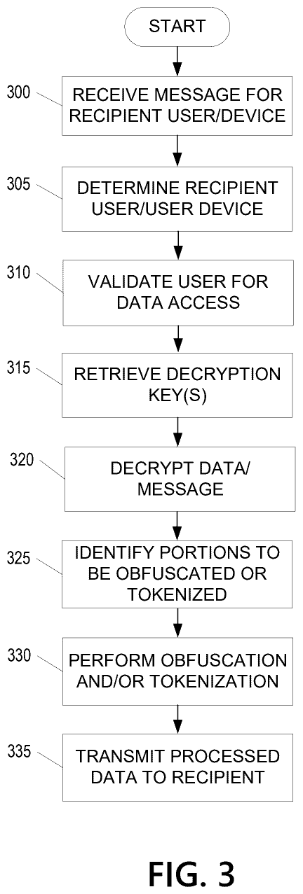

Data received for an end user device may be managed in similar fashion. FIG. 3 illustrates an example process by which data transmitted to a user device may be processed by an HSM edge device. In step 300, for example, an HSM edge device, acting as an intermediary device (e.g., a router or proxy server), may receive a message directed to a user device. As noted above, an HSM edge device may be a local system, device, or server that facilitates network communications, data access functionality, and other processes for one or more local user devices. In some examples, the message may include encrypted data.

In step 305, the HSM edge device may determine or otherwise identify a user and user device to which the message is directed. Additionally or alternatively, the HSM edge device may determine other data parameters such as a source of the communication, a data type of the information in the communication, whether the source of the data or communication is internal or external to an organization, a geographic location of the source of the data or communication, a user role, a device type, and the like and/or combinations thereof.

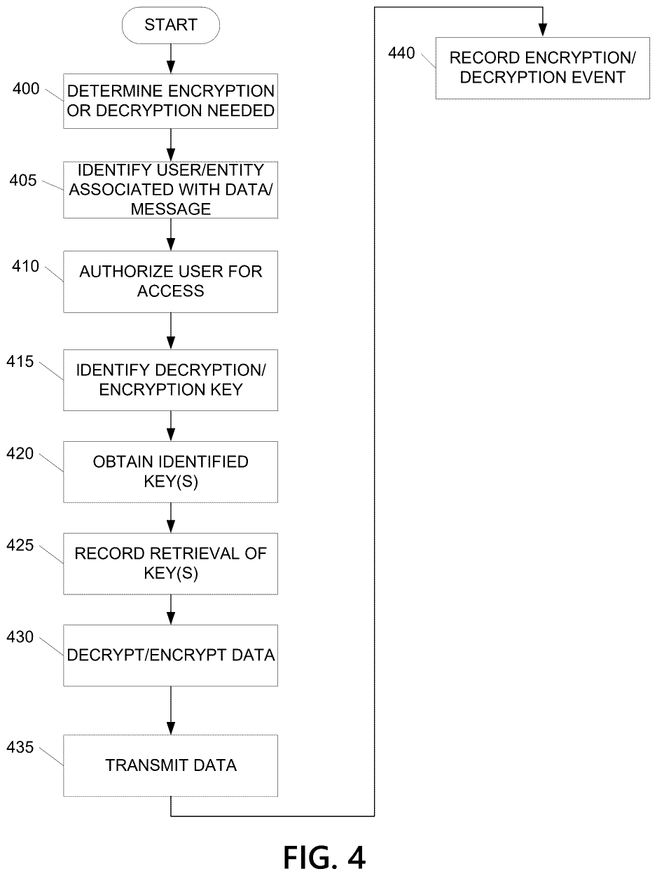

In step 310, the HSM edge device may validate the user for access to the data. For example, the HSM device may determine whether the user is authorized to receive and/or view the message and any data contained within the message. In some arrangements, the HSM edge device may validate or authorize the user based on portions or parts of the message and/or data. For example, the HSM edge device may be configured to determine whether different parts of the message and/or data require different levels or types of authorization. If so, the HSM edge device may evaluate each level or type of authorization against a recipient user or device's clearance or authorization level. According to some arrangements, the HSM edge device may perform the validation or authorization of a user using one or more smart contracts in a blockchain network, as described in further detail below with respect to FIG. 4.

If the user is determined to be authorized to view the message or data, the HSM edge device may, in step 315, retrieve decryption keys associated with the message or data if the message or data is encrypted. In one example, the decryption key (or decryption keys) may be stored locally in the HSM edge device or in another local or remote device, server, or system. According to one or more aspects, the HSM edge device may retrieve the decryption key(s) using a smart contract in a blockchain network.

In step 320, the HSM edge device may decrypt the data or message using the retrieved decryption key(s). In step 325, the HSM edge device may further evaluate whether portions of the data or message should be masked (e.g., obfuscated) or tokenized prior to providing the data or message to the recipient user and device. For example, even when a user is authorized to access data or messages, there may still be a policy that indicates that certain types of information (e.g., personally-identifiable information, financial information) contained within the message or data should be masked or tokenized for added security or privacy. These policies may be specified in association with the data or message transmission and/or may be configured as a general policy of which each HSM edge device may be aware. Additionally, these policies may be encoded as one or more smart contracts in a blockchain network, which may be invoked by the HSM edge device upon receipt and/or decryption of the message or data.

In step 330, if the HSM edge device determines that portions of the data or message are to be masked or tokenized, the HSM edge device may perform masking or tokenization of the information. Details of masking and tokenization are similar to those discussed with respect to FIG. 2, and throughout the description.

In step 335, the HSM edge device may then transmit the processed data and message to the intended recipient user at their user device. In one or more arrangements, the transmission may be encrypted or transmitted according to other security protocols such as virtual private network (VPN) tunnels.

As discussed, according to one or more aspects, one or more blockchains may be used to uniformly specify or otherwise enforce policies for data security and management across HSM edge devices of an organization or system. In one or more arrangements, these policies may be used in the determinations of steps 205, 215, and 220 to provide uniform decision-making. In some examples, such policies may be defined using smart contracts in the blockchain. For example, one or more smart contracts may specify whether particular types of data are to be encrypted, masked, tokenized and/or processed in a particular way for security and proper governance. Accordingly, when data is received for transmission, the HSM edge device may identify and access corresponding smart contracts in the blockchain based on various parameters such as a source entity, a destination entity, data type, department or organization associated with the data, transaction type (e.g., financial transactions), geographic location of the source, geographic location of the destination, and the like, in order to determine how the data is to be treated for transmission. In one or more examples, a data transmission may include parameters (e.g., metadata) that specifies a smart contract that may be used to authorize or validate a recipient user or device for accessing the message or data.

Moreover, blockchains and smart contracts may be used for authorization and validation. For example, when retrieving encryption or decryption keys, the HSM edge device may invoke a smart contract in the blockchain network to determine whether a user is authorized (e.g., has the appropriate permissions, authority, and/or security clearance levels) to retrieve those keys. For example, when a user sends data (e.g., FIG. 2), the HSM edge device may determine whether the sending user has authorization to access and/or use the requested encryption key. In another example, when receiving encrypted data, the HSM edge device may determine whether the receiving user has authorization to view or access the data, and thus, whether the user is authorized to access and/or use the appropriate decryption keys. These decisions and determinations may be facilitated by and made using smart contracts.

FIG. 4 is a flowchart illustrating a process for using a blockchain to manage data access control. In step 400, an HSM edge device may determine that encryption or decryption of data or a message is required. For example, this determination may be made in response to receiving a request from a user device to transmit data (e.g., FIG. 2) or a message or data received by HSM edge device for delivery to a user device (e.g., FIG. 3). As discussed with respect to FIGS. 2 and 3, in either case, data or other information may need to be encrypted or decrypted. Accordingly, corresponding keys or cryptographic information may be needed to perform such encryption and decryption.

In step 405, the HSM edge device may determine or identify a user or entity associated with the transmission or receipt of the data or message. For example, a sending user or device may be identified in a request to transmit data. Similarly, a recipient user or device may be identified in a message or data received by the HSM edge device.

Once a recipient or sending user has been identified, the HSM edge device may invoke a smart contract with a blockchain network to determine whether the user or entity is authorized to access the encryption or decryption keys or other cryptographic information in step 410. The smart contract may take one or more user or device parameters as input and automatically execute code that indicates whether that user or device is authorized to use or otherwise access the cryptographic information. In some arrangements, the HSM edge device may first select or identify a smart contract to use for authorization or validation based on various parameters such as a data transaction type, type of data to be accessed, access type (e.g., read-only, read/write), geographic location, device type, and the like and/or combinations thereof. For example, a first smart contract may be used to authorize users or entities using a mobile device while a second smart contract may be used to authorize users or entities using a desktop or laptop computer. In such cases, the first smart contract may require higher levels of verification or authentication (e.g., multi-factor authentication). In other examples, the first smart contract may require lower levels of verification or authentication (e.g., single-factor authentication). Accordingly, the HSM edge device may determine the appropriate smart contract to use for a particular entity or user.

If the user or entity is determined to be authorized, the system may then identify a decryption key for decrypting the data or encryption key for encrypting the data, as appropriate, in step 415. In some examples, encrypted data may include metadata or other flags or information which indicate the decryption key to be used. Similarly, data may include metadata or other flags or information which indicate the encryption key to be used in securing the information. For instance, information associated with the encrypted data may indicate the data is encrypted using a particular user or entity's encryption key. In other examples, decryption or encryption keys may be associated with a particular geographic location, organization, data type, data security or confidentiality level, and the like and/or combinations thereof.

Once identified, the HSM edge device may then obtain the decryption or encryption key in step 420. Obtaining the key may include retrieval from a local storage of the system. In other arrangements, the key may include retrieval from a remote storage device or system through a network. Additionally, in step 425, upon obtaining the decryption key or encryption key, the edge device may record the retrieval of the key as a transaction record in a blockchain. For example, the system may generate a new node in a blockchain with data specifying that the decryption key or encryption key was retrieved at a particular time and date, by a particular user or entity, for accessing (or encrypting) a particular type of data or for accessing a specific data file or container (e.g., with a data identifier), using a particular device or type of device, at a particular geographic location and/or network location, and the like and/or combinations thereof. By recording the key access in the blockchain, an immutable and verifiable record of that action may be maintained and later reviewed as needed. For example, this record may be used to perform security audits and the like. In some arrangements, recordkeeping of functions or processes performed (e.g., retrieval of a key, masking of data, tokenization of data, data receipt or transmission) may be recorded to a different blockchain than a blockchain storing the smart contracts and/or policies. Additionally or alternatively, each different type of data function or process may have its own specific recordkeeping blockchain.

In step 430, the HSM edge device may then proceed to decrypt the data using the obtained decryption key or encrypt the data using an obtained encryption key. Once decrypted or encrypted, the HSM edge device may transmit the data to a destination user or entity device (e.g., a requesting user or entity device) in step 435. As with the decryption and encryption key access, the HSM edge device may also record the data decryption and access event or transaction or encryption event by the user or entity to a blockchain in step 440. For example, the HSM edge device may generate a new node in the blockchain corresponding to the data access (e.g., decryption, encryption, viewing or reading) event or transaction.

The same process for creating a record of a transaction or function performance may be used for a variety of types of data transactions or functions. Examples of transactions or functions that may be recorded include data modification, login events, authorizations, data deletion, data transmission, data receipt, data copying, and the like and/or combinations thereof. Recording the transaction to a blockchain may include storing a variety of data to a blockchain node including an action taken or function or smart contract invoked, a user for which the data was modified, a device or device type associated with the action taken (e.g., a recipient or destination device, a source device), an organization associated with the data, a data type, a time and date of the action, a source and/or destination associated with the transaction, and the like and/or combinations thereof.

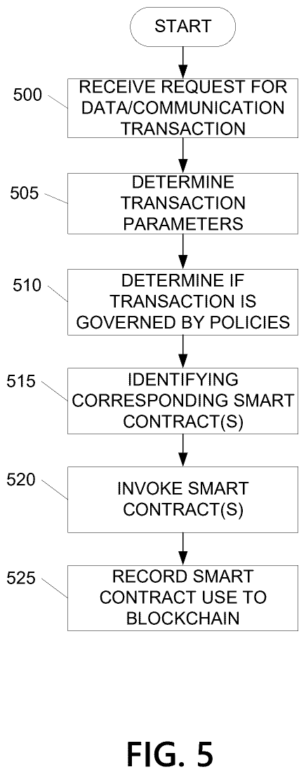

FIG. 5 is a flowchart illustrating a process for using smart contracts in a blockchain to perform one or more transactions and functions. According to one or more aspects, smart contracts in a blockchain may be used to provide uniform policies, processes, and functions across a network, system, organization, a business, and the like. For example, HSM edges devices in a system may invoke or otherwise use the same set of smart contracts, which may define actions, rules, guidelines, executable code, and the like. Accordingly, the same smart contracts may provide the same policies, functions and processes for use across all users or devices in an organization. Smart contracts may also be specific to various types of parameters, including data or message type, a data or message transaction type (read, write, transmission, save, modify, etc.), data or message size, data or message sensitivity or confidentiality, a source user or device, a destination user or device, a device type, operating system, a user role, and the like and/or combinations thereof.

In step 500, an HSM edge device may receive a request for a data or communication transaction. A transaction may refer to any action taken on or with data, including accessing data, modifying data, decrypting data, encrypting data, creating data, saving data, moving data, sending a message, receiving a message, storing a message, forwarding a message, device commands (e.g., shutdown, reboot, execute applications or other code, lockdown, enter sleep state), financial transactions, other computer functions, and the like.

In step 505, the HSM edge device may determine data or message transaction parameters, including the type of data or message transaction requested. In some arrangements, the HSM edge device may also determine a user, user role, device, device type, an organization (e.g., department, division), data size, and the like. In step 510, using the data or message transaction parameters, the HSM edge device may determine whether the type of transaction is governed by or is otherwise associated with one or more smart contracts or policies. For example, certain transaction types or user roles or data or messages types may require certain security measures. Accordingly, those security measures may be enforced by smart contracts in a blockchain. In another example, data may have a specified level of security or confidentiality. Accordingly, smart contracts (e.g., policies) may be defined to protect that data with one or more security protocols such as encryption, masking, tokenization, and the like. These smart contracts may be invoked to perform data modification such as encryption processing (e.g., retrieval of keys and encryption using those keys), secure transmissions (e.g., using a VPN), data masking, data tokenization, and the like and/or combinations thereof. In some arrangements, one or more transaction parameters may be governed by multiple policies or smart contracts. In such cases, each of the smart contracts may be invoked and executed for those transactions. For example, for an incoming data transmission, a smart contract may be invoked for perform data decryption, while another smart contract may be invoked for data masking.

In step 515, if the transaction parameters indicate that one or more smart contracts are to be used, the HSM edge device may identify the corresponding smart contract(s) in the blockchain. For example, the HSM edge device may determine the smart contract address or identifier. Subsequently, in step 520, the HSM edge device may invoke the identified smart contract or smart contracts to process the data or message. For example, and as discussed, invoking the smart contract may cause masking, encryption/decryption, tokenization and the like to be performed on the data.

In step 525, the HSM edge device may record the smart contract invocation event in a blockchain to provide an auditable trail. In some examples, the event may be recorded in a smart contract invocation record blockchain. In other examples, the event may be recorded in the same blockchain as the blockchain storing the smart contract. The recordation (e.g., in a node in a blockchain) may include a variety of information including an action taken or function or smart contract invoked, a user for which the data was modified, a device or device type associated with the action taken (e.g., a recipient or destination device, a source device), an organization associated with the data, a data type, a time and date of the action, a source and/or destination associated with the transaction, and the like and/or combinations thereof.

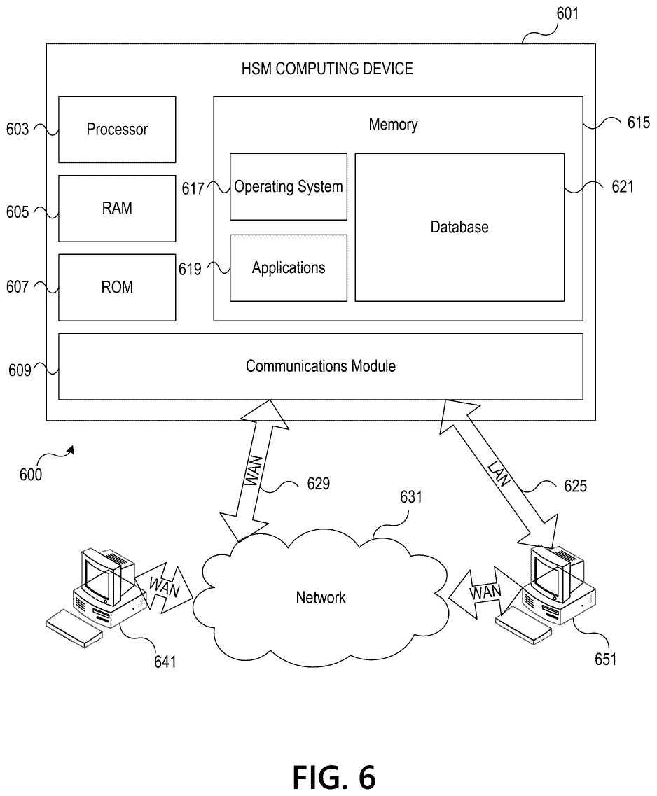

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include HSM computing device 601 having processor 603 for controlling overall operation of HSM computing device 601 and its associated components, including Random Access Memory (RAM) 605, Read-Only Memory (ROM) 607, communications module 609, and memory 615. HSM computing device 601 may include a variety of computer readable media. Computer readable media may be any available media that may be accessed by HSM computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by HSM computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on HSM computing device 601. Such a processor may execute computer-executable instructions stored on a computer-readable medium.

Software may be stored within memory 615 and/or storage to provide instructions to processor 603 for enabling HSM computing device 601 to perform various functions as discussed herein. For example, memory 615 may store software used by HSM computing device 601, such as operating system 617, application programs 619, and associated database 621. Also, some or all of the computer executable instructions for HSM computing device 601 may be embodied in hardware or firmware. Although not shown, RAM 605 may include one or more applications representing the application data stored in RAM 605 while HSM computing device 601 is on and corresponding software applications (e.g., software tasks) are running on HSM computing device 601.

Communications module 609 may include a microphone, keypad, touch screen, and/or stylus through which a user of HSM computing device 601 may provide input, and may also include one or more of a speaker for providing audio output and a video display device for providing textual, audiovisual and/or graphical output. Computing system environment 600 may also include optical scanners (not shown).

HSM computing device 601 may operate in a networked environment supporting connections to one or more other computing devices, such as computing device 641 and 651. Computing devices 641 and 651 may be personal computing devices or servers that include any or all of the elements described above relative to HSM computing device 601.

The network connections depicted in FIG. 6 may include Local Area Network (LAN) 625 and Wide Area Network (WAN) 629, as well as other networks. When used in a LAN networking environment, HSM computing device 601 may be connected to LAN 625 through a network interface or adapter in communications module 609. When used in a WAN networking environment, HSM computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A system comprising:
a plurality of user devices;
one or more central servers configured to perform one or more functions in response to requests from the plurality of user devices; and
a plurality of edge devices, each of the edge devices including a hardware security module configured to enforce security policies for data transactions, the hardware security module including one or more hardware-secure cryptoprocessors,
wherein each of the plurality of user devices is located geographically closer to at least a respective one of the plurality of edge devices than to the one or more central servers,
wherein at least one of the plurality of edge devices is configured to:
receive a request to send data to or receive data from the one or more central servers;
determine one or more request parameters;
determine one or more security policies associated with the request based on the determined one or more request parameters, the one or more security policies indicating a manner in which the data is to be secured;
identify one or more nodes in a blockchain corresponding to the determined one or more security policies; and
perform a security processing function on the data based on security policy data stored in the identified one or more nodes, wherein the security processing function includes at least one of: encryption and decryption of the data.

2. The system of claim 1, wherein the one or more request parameters includes a device type of a device from which the request was received and a user identifier associated with the request.

3. The system of claim 1, wherein each of the plurality of user devices is connected to the at least a respective one of the plurality of edge devices through a local network.

4. The system of claim 1, wherein the one or more nodes in the blockchain include a smart contract, and wherein performing the security processing function includes executing the smart contract.

5. The system of claim 1, wherein performing the security processing function includes:
determining a decryption key associated with the data; and
decrypting the data using the decryption key.

6. The system of claim 1, wherein the at least one of the plurality of edge devices is further configured to generate a transaction record of the security processing function in the blockchain.

7. The system of claim 1, wherein at least one of the plurality of edge devices is further configured to perform one of:
before encrypting the data, modifying the data to mask one or more portions of the data; or
after decrypting the data, modifying the unencrypted data to mask one or more portions of the data prior to sending the unencrypted data to one or more recipient devices.

8. The system of claim 1, wherein the request parameters include a sensitivity level of the data.

9. An apparatus comprising:
a processor;
a hardware security module comprising one or more hardware-secure cryptoprocessors; and
memory storing computer-readable instructions that, when executed by the processor, cause the apparatus to:
receive a request to send data to or receive data from one or more central servers located geographically remotely from the apparatus;
determine one or more request parameters;
determine one or more security policies associated with the request based on the determined one or more request parameters, the one or more security policies indicating a manner in which the data is to be secured;
identify one or more nodes in a blockchain corresponding to the determined one or more security policies; and
performing a security processing function on the data based on security policy data stored in the identified one or more nodes, wherein the security processing function includes at least one of: encryption and decryption of the data.

10. The apparatus of claim 9, wherein the one or more request parameters includes a device type of a device from which the request was received and a user identifier associated with the request.

11. The apparatus of claim 9, wherein the one or more nodes in the blockchain include a smart contract, and wherein performing the security processing function includes executing the smart contract.

12. The apparatus of claim 9, wherein performing the security processing function includes:
determining a decryption key associated with the data; and
decrypting the data using the decryption key.

13. The apparatus of claim 9, wherein the instructions, when executed, further cause the apparatus to generate a transaction record of the security processing function in the blockchain.

14. The apparatus of claim 9, wherein the instructions, when executed, further cause the apparatus to perform one of:
before encrypting the data, modifying the data to mask one or more portions of the data; or
after decrypting the data, modifying the unencrypted data to mask one or more portions of the data prior to sending the unencrypted data to one or more recipient devices.

15. The apparatus of claim 9, wherein the request parameters include a sensitivity level of the data.

16. A method comprising:
receiving, by a hardware-secure edge device having at least one hardware-secure cryptoprocessor, a request to send data to or receive data from the one or more central servers located geographically remotely from the hardware-secure edge device;
determining, by the hardware-secure edge device, one or more request parameters;
determining, by the hardware-secure edge device, one or more security policies associated with the request based on the determined one or more request parameters, the one or more security policies indicating a manner in which the data is to be secured;
identifying, by the hardware-secure edge device, one or more nodes in a blockchain corresponding to the determined one or more security policies; and
executing, by the hardware-secure edge device, a security processing function on the data based on security policy data stored in the identified one or more nodes, wherein the security processing function includes at least one of: encryption and decryption of the data.

17. The method of claim 16, wherein the one or more request parameters includes a device type of a device from which the request was received and a user identifier associated with the request.

18. The method of claim 16, wherein the one or more nodes in the blockchain include a smart contract, and wherein performing the security processing function includes executing the smart contract.

19. The method of claim 16, wherein performing the security processing function includes:
determining a decryption key associated with the data; and
decrypting the data using the decryption key.

20. The method of claim 16, further comprising generating a transaction record of the security processing function in the blockchain.
